(19) United States
(12) Patent Application Publication
(10) Pub. No.: US 2025/0181849 A1
(43) Pub. Date: Jun. 5, 2025

(54) SYSTEMS AND METHODS FOR SMART ENTITY CLONING

(71) Applicant: YAHOO ASSETS LLC, New York, NY (US)

(72) Inventor: Praveen Parayampathil NARAYANAN, Toronto (CA)

(21) Appl. No.: 18/528,874

(22) Filed: Dec. 5, 2023

(51) Int. Cl. G06F 40/56; G06N 3/08; G06Q 30/0241

(52) U.S. Cl. CPC G06F 40/56; G06N 3/08; G06Q 30/0241

(57) ABSTRACT

In some implementations, the techniques described herein relate to a method including: (i) receiving, by a processor, text content from an entity that stores the text content as a data object associated with the entity, (ii) generating, by the processor, a prompt for a large language model that comprises the text content and directions for modifying the text content, (iii) providing, by the processor, the prompt to the large language model, (iv) executing, by the processor, the large language model, the execution causing creation of modified text content in accordance with the directions for modifying the text content from the prompt; (v) receiving, by the processor from the large language model, the modified text content, and (vi) creating, by the processor, a new data object that stores the modified text content in association with the entity.

### BACKGROUND

Businesses wishing to run an entity, such as electronic media, will often create multiple versions of this entity. Sometimes these different versions will target different demographics or emphasize different features of the product, while in other cases each version will be fairly similar but with small differences that can be refined through A/B testing. In any case, manually creating many different versions of an entity that may include dozens or hundreds of individual elements is a tedious process that scales poorly.

### BRIEF DESCRIPTION OF THE DRAWINGS

FIG. 1 is a block diagram illustrating a system for smart entity cloning according to some of the example embodiments.

FIG. 2 is a flow diagram illustrating a method for smart entity cloning according to some of the example embodiments.

FIG. 3 is an illustration of example inputs and outputs of a system for smart entity cloning according to some of the example embodiments.

FIG. 4 is a flow diagram illustrating a method smart entity cloning according to some of the example embodiments.

FIG. 5 is a block diagram of a computing device according to some embodiments of the disclosure.

### DETAILED DESCRIPTION

Various machine learning (ML) and artificial intelligence (AI) models are capable of generating text. One example of such a model is a large language model (LLM). An LLM is a statistical model that predicts the next word in a sequence, given the previous words (often referred to as a “prompt”). LLMs are trained on massive datasets of text, and can be used for a variety of tasks, such as text generation, translation, and question answering. LLMs are typically composed of a neural network with many parameters (typically billions of weights or more). The neural network is trained on a large dataset of text and learns to predict the next word in a sequence, given the previous words. While LLMs are used primarily in the following description, the embodiments described herein can apply equally to other types of text generation models including, but not limited to, long short-term memory (LSTM) models, recurrent neural networks (RNNs), encoder-decoder models, transformer-based models, specialized convolutional neural networks (CNNs) and the like.

The example embodiments herein describe methods, computer-readable media, device, and systems that enable users to efficiently and intelligently clone advertisement entities such as campaigns by providing the existing entity to an LLM that is instructed to create a new version of the entity with changes of a specified type. For example, the systems described herein may change the target demographic of an entity, change the language of an entity, and/or change the configuration of the entity to match a different physical device (e.g., a mobile phone ad to a laptop ad). In some implementations, the systems described herein may use an LLM specially trained on advertisement data to understand advertisement terms and/or may train the LLM with user feedback based on users' reactions to generated entities.

In some aspects, the techniques described herein relate to a method including: (i) receiving, by a processor, text content from an entity that stores the text content as a data object associated with the entity, (ii) generating, by the processor, a prompt for a large language model that comprises the text content and directions for modifying the text content, (iii) providing, by the processor, the prompt to the large language model, (iv) executing, by the processor, the large language model, the execution causing creation of modified text content in accordance with the directions for modifying the text content from the prompt; (v) receiving, by the processor from the large language model, the modified text content, and (vi) creating, by the processor, a new data object that stores the modified text content in association with the entity.

In some aspects, the techniques described herein relate to a method, where: receiving the text content includes receiving the text content as input via a graphical user interface for creating content associated with the entity, the graphical user interface including multiple fields, and creating the new data object that stores the modified text content includes populating the multiple fields of the graphical user interface with the text content.

In some aspects, the techniques described herein relate to a method, where the large language model includes a specialized large language model trained on advertising entity data to modify text content associated with entities.

In some aspects, the techniques described herein relate to a method, where: the directions for modifying the text content include directions to translate the text content into a human-readable language that is different from an original human-readable language of the text content, and the modified text content includes text in the human-readable language.

In some aspects, the techniques described herein relate to a method, where the modified text content includes a JavaScript object notation object (JSON).

In some aspects, the techniques described herein relate to a method, where the data object includes an advertisement campaign and the text content includes a plurality of advertisement blurbs.

In some aspects, the techniques described herein relate to a method, further including: identifying, by the processor, a plurality of images associated with the entity, and selecting, by an algorithm executed by the processor, at least one image to pair with the modified text content, where the at least one image is selected based at least in part on the plurality of images.

In some aspects, the techniques described herein relate to a method, where: the text content includes content configured to be displayed on a first category of physical device, the modified text content includes content configured to be displayed on a second category of physical device that is different from the first category of physical device, and the directions for modifying the text content include instructions to configure the modified text content to be displayed on the second category of physical device.

In some aspects, the techniques described herein relate to a method, further including: receiving feedback from a user about the modified text content and providing the modified text content and the feedback to the LLM as training data.

In some aspects, the techniques described herein relate to a method wherein the entity comprises a third-party entity, wherein the third-party entity comprises an advertisement entity.

In some aspects, the techniques described herein relate to a non-transitory computer-readable storage medium for tangibly storing computer program instructions capable of being executed by a computer processor, the computer program instructions defining steps of: (i) receiving, by a processor, text content from an entity that stores the text content as a data object associated with the entity, (ii) generating, by the processor, a prompt for a large language model that comprises the text content and directions for modifying the text content, (iii) providing, by the processor, the prompt to the large language model, (iv) executing, by the processor, the large language model, the execution causing creation of modified text content in accordance with the directions for modifying the text content from the prompt; (v) receiving, by the processor from the large language model, the modified text content, and (vi) creating, by the processor, a new data object that stores the modified text content in association with the entity.

In some aspects, the techniques described herein relate to a non-transitory computer-readable-medium, where: receiving the text content includes receiving the text content as input via a graphical user interface for creating content associated with the entity, the graphical user interface including multiple fields, and creating the new data object that stores the modified text content includes populating the multiple fields of the graphical user interface with the text content.

In some aspects, the techniques described herein relate to a non-transitory computer-readable-medium, where the large language model includes a specialized large language model trained on advertising entity data to modify text content associated with entities.

In some aspects, the techniques described herein relate to a non-transitory computer-readable-medium, where: the directions for modifying the text content include directions to translate the text content into a human-readable language that is different from an original human-readable language of the text content, and the modified text content includes text in the human-readable language.

In some aspects, the techniques described herein relate to a non-transitory computer-readable-medium, where the modified text content includes a JSON object.

In some aspects, the techniques described herein relate to a non-transitory computer-readable-medium, where the data object includes an advertisement campaign and the text content includes a plurality of advertisement blurbs.

In some aspects, the techniques described herein relate to a non-transitory computer-readable-medium, further including: identifying, by the processor, a plurality of images associated with the entity, and selecting, by an algorithm executed by the processor, at least one image to pair with the modified text content, where the at least one image is selected based at least in part on the plurality of images.

In some aspects, the techniques described herein relate to a non-transitory computer-readable-medium, where: the text content includes content configured to be displayed on a first category of physical device, the modified text content includes content configured to be displayed on a second category of physical device that is different from the first category of physical device, and the directions for modifying the text content include instructions to configure the modified text content to be displayed on the second category of physical device.

In some aspects, the techniques described herein relate to a non-transitory computer-readable-medium, further including: receiving feedback from a user about the modified text content and providing the modified text content and the feedback to the LLM as training data. In some aspects, the techniques described herein relate to a device including: a processor, and a storage medium for tangibly storing thereon logic for execution by the processor, the logic including instructions for: (i) receiving, by the processor, text content from an entity that stores the text content as a data object associated with the entity, (ii) generating, by the processor, a prompt for a large language model that comprises the text content and directions for modifying the text content, (iii) providing, by the processor, the prompt to the large language model, (iv) executing, by the processor, the large language model, the execution causing creation of modified text content in accordance with the directions for modifying the text content from the prompt; (v) receiving, by the processor from the large language model, the modified text content, and (vi) creating, by the processor, a new data object that stores the modified text content in association with the entity.

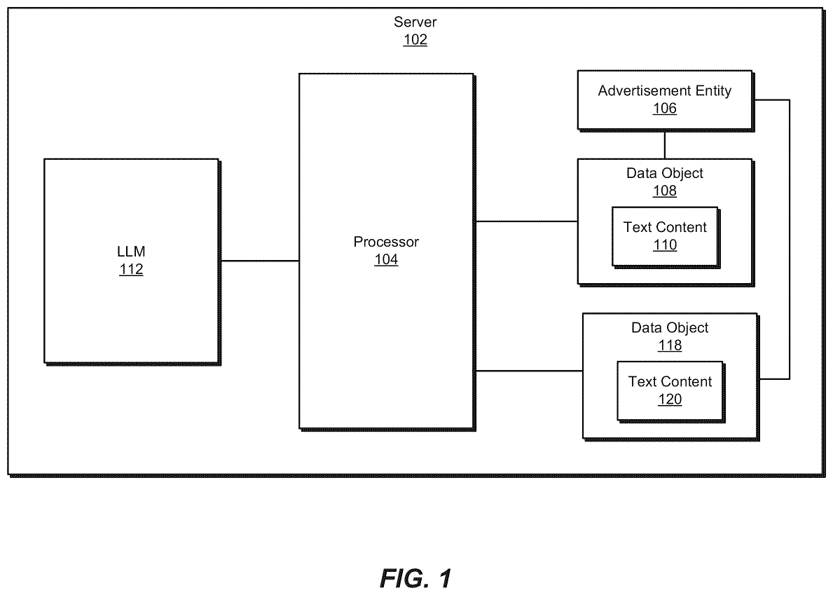

FIG. 1 is a block diagram illustrating a system for smart entity cloning according to some of the example embodiments.

The illustrated system includes a server 102. Server 102 may be configured with a processor 104 that receives text content 110 from an entity 106 that stores text content 110 as a data object 108. Processor 104 may generate prompt for an LLM 112 that includes text content 110 and directions for modifying the text content 110 and may provide this prompt to LLM 112. Next, processor 104 may executing LLM 112, the execution causing creation of modified text content 120 and may receive modified text content 120 created at least in part by applying, by LLM 112, the directions for modifying text content 110 to text content 110. In some implementations, processor 104 may create a new data object 118 that stores text content 120 in association with entity 106.

Although illustrated here on server 102, any or all of the systems described herein may be hosted by one or more servers and/or cloud-based processing resources and/or client devices. Further details of these components are described herein and in the following flow diagrams.

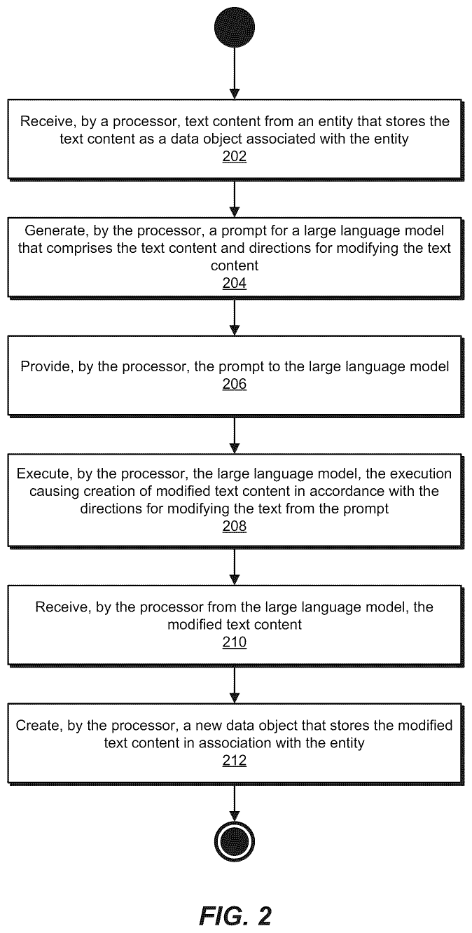

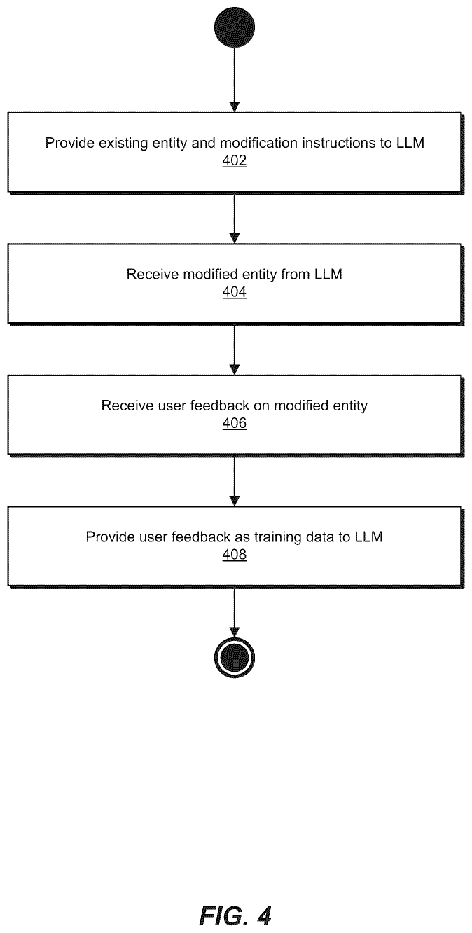

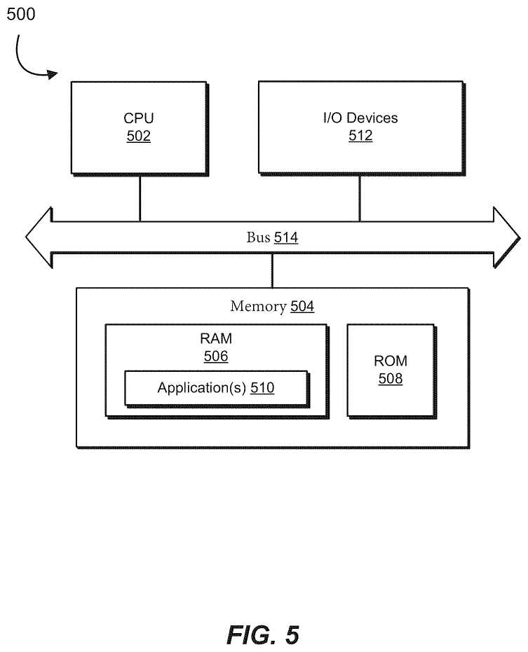

In the various implementations, server 102, processor 104, and LLM 112 can be implemented using various types of computing devices such as laptop/desktop devices, mobile devices, server computing devices, etc. Specific details of the components of such computer devices are provided in the description of FIG. 5 which are not repeated herein. In general, these devices can include a processor and a storage medium for tangibly storing thereon logic for execution by the processor. In some implementations, the logic can be stored on a non-transitory computer readable storage medium for tangibly storing computer program instructions. In some implementations, these instructions can implement some of all of the methods described in FIG. 2 and FIG. 4.

In some implementations, entity 106 can include an advertisement entity. For example, entity 106 may include any type of organizational structure and/or item of media for advertising. In some examples, entity 106 may include an individual ad, such as text, an image, additional media, and/or a combination of the above. In some examples, entity 106 may include a line that includes a collection of ads with similar qualities, such as ads aimed at a specific demographic, ads to be displayed in a specified region, ads to be displayed on a specified platform, etc. In one example, entity 106 may include a campaign that includes multiple lines and/or ads.

In some implementations, data objects 108 and/or 118 may include any type of data structure associated with an entity. For example, data object 108 may be a sub-entity associated with a larger entity, such as a line associated with a campaign or an ad associated with a line. In one implementation, a data object may be content associated with an entity, such as text content associated with an ad that includes text and/or other media content. In some implementations, the systems described herein may store data objects 108 and/or 118 in a database.

In some implementations, text content 110 and/or 120 may include any type of text, including individual words, phrases, sentences, paragraphs, and so forth. In some examples, text content 110 and/or 120 may include metadata such as formatting information (e.g., line breaks, bolding, font size, etc.), language information, etc. In one implementation, text content 110 may be formatted to be human-readable. Alternatively, text content 110 may be formatted for display in a user interface. For example, text content 110 may be formatted as a JSON object.

FIG. 2 is a flow diagram illustrating a method for smart entity cloning according to some of the example embodiments.

In step 202, the method can include receiving, by a processor, text content from an entity that stores the text content as a data object associated with the entity.

The systems described herein may receive the text content in a variety of ways and/or contexts. For example, the systems described herein may be configured as part of an advertisement campaign management platform and/or tool. In this example, a user may locate a pre-existing advertisement campaign or other entity (e.g., line, ad) and interact with a user interface element such as a “clone campaign” button that initiates the process of providing the text content to the processor to be provided to the LLM.

In some implementations, the systems described herein may also receive instructions from a user on how to modify the text content. In one implementation, the systems described herein may receive these instructions in a freeform text box, such as a chat interface with an LLM. Additionally, or alternatively, the systems described herein may receive the instructions from other user interface elements, such as a dropdown menu of options, checkboxes, and so forth. For example, a user may identify a campaign for a first movie, select a second movie from a dropdown list of products, and instruct the system to clone the campaign but make the new version about the second movie instead of the first. In another example, a user may enter text such as, “translate all ads in this line into French.”

In step 204, the method can include generating, by the processor, a prompt for an LLM that includes the text content and directions for modifying the text content.

The systems described herein may generate the prompt in a variety of ways. In some implementations, the systems described herein may store a set of prewritten prompts with or without customization options. For example, the systems described herein may store different prewritten prompts for different types of common modifications such as changing the product, language, demographic target, physical device, and/or intended outcome of the ad.

Example Product Prompt: Generate text for an advertising campaign for [Product A] based on the below text, an advertising campaign for [Product B]. Copy the style and tone of the text as closely as possible while replacing all references to [Product A] with references to [Product B].

Example Language Prompt: Translate the below text from English to French. Preserve the tone and style of the text as much as possible. Translate all instances of [English product name] to [French product name].

Example Demographic Prompt: You are an advertising specialist tasked with generating a witty, engaging advertising campaign. The below text is a set of advertisements for a product aimed at [Demographic A]. Rewrite the text to advertise the same product to [Demographic B].

Example Device Prompt: The below text is an ad designed to be displayed on desktop devices. Rewrite the ad for a mobile device by condensing the text to 100 characters. Be sure to keep the most important verbs.

Example Outcome Prompt: The below text is an ad optimized to get users to read the text of the ad. Rewrite the text to be optimized for a call to action that involves the user clicking on the ad.

In some implementations, the systems described herein may generate prompts with negative limitations designed to avoid problematic content. For example, the systems described herein may append the sentence, “Avoid offensive humor or references to competing products” to all prompts.

In step 206, the method can include providing, by the processor, the prompt to the LLM.

In some implementations, the systems described herein may provide the prompt to a generic LLM that has not been specially trained on any field-specific data. Alternatively, the systems described herein may provide the prompt to an LLM that has been specially trained on advertising-related data. For example, the LLM may have been trained to recognize words such as segment and line in an advertising or marketing context (as opposed to, e.g., a geometry context or a colloquial context) and may correctly interpret input such as “Modify this line to target a different segment” without additional elaboration.

In some implementations, the systems described herein may provide a prompt to a generative machine learning model in addition to providing the prompt to the LLM. For example, an entity may include text and images and the systems described herein may prompt the generative machine learning model to create images to be displayed alongside the text content output by the LLM. In some implementations, the systems described herein may provide the generative machine learning model with existing images (e.g., from the same source entity as the text content, from a product image gallery, etc.) and/or all or a portion of the text content as a prompt.

Example Generative Model Prompt: Generate an image similar to the attached three images incorporating keywords from the below text.

In step 208, the method can include executing, by the processor, the LLM, the execution causing creation of modified text content in accordance with the directions for modifying the text content from the prompt.

The systems described herein may execute the LLM in a variety of ways and/or contexts. For example, the systems described herein may execute an LLM specifically trained on ad content. In another example, the method may execute a generic LLM. In some implementations, the systems described herein may execute multiple LLMs in parallel (e.g., with the same or different prompts). In one implementation, the systems described herein may execute a third-party LLM.

In step 210, the method can include receiving, by the processor from the LLM, modified text content.

In some implementations, the systems described herein may receive the modified text content as one item of output and may parse the modified text content into multiple data objects. For example, the systems described herein may provide six ads to the LLM to be rewritten to target a different demographic, may receive all six ads as a single instance of text output, and may parse this text output into six parts. Additionally, or alternatively, the systems described herein may send multiple batches of input to the LLM consecutively and/or currently and may receive multiple batches of output. For example, if the systems described herein are cloning an entire campaign, the systems described herein may send each ad within the campaign to the LLM as a separate item of input and receive each modified ad as a separate item of output. In some implementations, the systems described herein may operate multiple instances of the LLM to facilitate consecutive processing.

In step 212, the method can include creating, by the processor, a new data object that stores the modified text content in association with the entity.

In some examples, the new data object may be associated with the entity because the new data object is a subset of the entity. For example, if the modified text is a new ad or line for an advertising campaign, the new data object may be associated the advertisement campaign of which it is a part. In other examples, the new data object may be associated with the entity via a stored history. For example, if the new data object is an advertisement campaign for a different product than the original advertisement campaign used as source data, the systems described herein may store metadata listing the new advertisement campaign as a modified clone of the original advertisement campaign.

In one implementation, the systems described herein may display the modified text content to the user in the same GUI that the user to view and/or enter the original text content. For example, if the GUI included several different form fields with different text and/or numerical values such as campaign name, campaign theme, line name, line goal, line demographic, ad short name, ad title, ad content, etc., the systems described herein may fill in all of the relevant fields with the modified content.

In some implementations, the systems described herein may enable a user to create multiple new entities at once. For example, a user interface may enable a user to enter or select a number of new campaigns, lines, or ads to generate and generate those new entities with a single button click. In one implementation, the systems described herein may enable a user to create many variations on an existing advertising campaign with the same structure (e.g., lines aimed at the same demographics, regions, and/or devices, the same number and type of ads in each line, etc.), preview these new campaigns, and select one or more to run. For example, a user may locate an existing campaign for an action movie, provide data about a new action movie, and create ten potential campaigns for the new action movie with the same structure as the existing campaign but ads describing the new action movie.

In one implementation, the systems described herein may enable a user to modify the budget allocated to an entity. For example, the systems described herein may instruct the LLM to create a version of a campaign that uses 30% of the budget and the LLM may output a version of the campaign with fewer lines and/or ads. In another example, the systems described herein may instruct the LLM to create a version of a campaign with the budget equally split among five lines instead of the original seven lines and the LLM may output a version of the campaign with additional ads in each line.

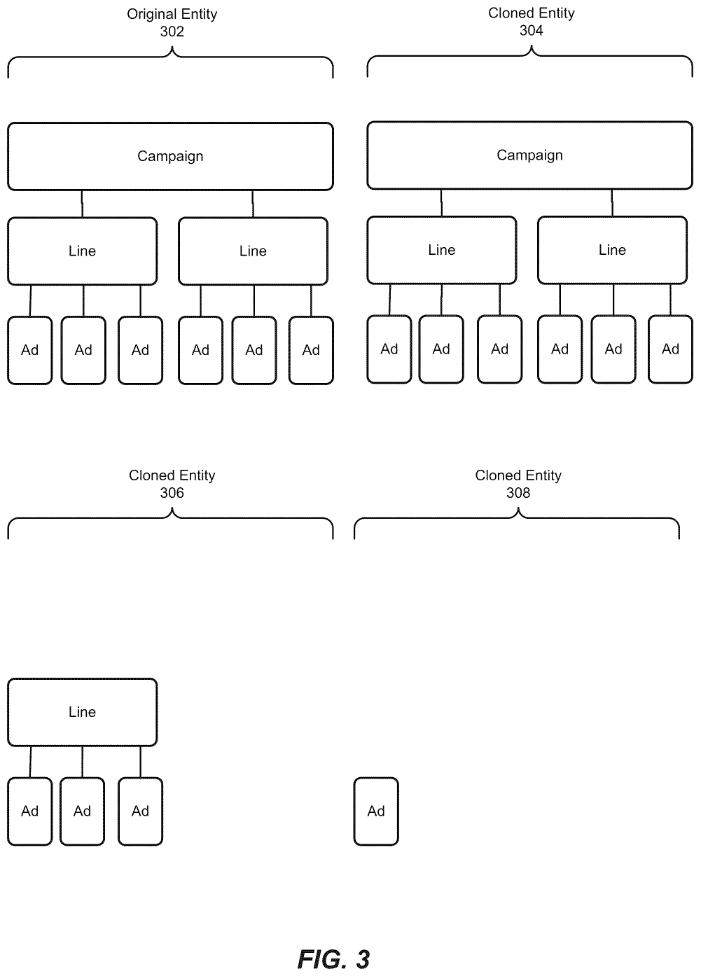

In some examples, the systems described herein may clone an entire campaign to create a new campaign while in other examples, the systems described herein may clone part of a campaign. For example, as illustrated in FIG. 3, the systems described herein may receive original entity 302 as input. In this example, original entity 302 may be an advertising campaign with multiple lines that each include multiple ads. In one example, the systems described herein may receive user input instructing the systems described herein to clone the entire campaign and may create cloned entity 304, an advertising campaign with the same structure of multiple lines that each include multiple ads, connected in the same way as in original entity 302, but with modified content throughout. Maintaining the structure of the campaign in this way may provide efficiency and convenience for the user, avoiding the need for the user to manually recreate all the relevant associative links when creating a campaign with the same or similar structure to an existing campaign.

In another example, the systems described herein may receive user input instructing the systems described herein to clone a single line from original entity 302 and may produce as output cloned entity 306, a modified version of a single line and the multiple ads that are part of the line. In some examples, cloned entity 306 may be a new line for the campaign of original entity 302 while in other examples, cloned entity 306 may be a new line for a different campaign. For example, original entity 302 may be an advertising campaign for a Canadian product and cloned entity 306 may be a French version of one of the lines targeted at consumers in Quebec.

In one example, the systems described herein may receive user input instructing the systems described herein to clone a single ad from original entity 302 and may produce as output cloned entity 308, a modified version of that single ad. In some examples, cloned entity 308 may be an additional ad for the same line as the original ad. For example, cloned entity 308 may be a slightly tweaked version of an ad aimed at the same demographic and containing similar information about the product but worded in a different way.

In some embodiments, the systems described herein may provide reinforcement learning with user feedback. For example, as illustrated in FIG. 4, in step 402, the systems described herein can include providing an existing entity and modification instructions to the LLM. In step 404, the systems described herein may receive the modified entity from the LLM. The systems described herein may then display the modified entity to the user, for example in a graphical user interface.

In step 406, the systems described herein may receive user feedback on the modified entity. This user feedback may take various forms. For example, the user feedback may be direct user feedback, such as detecting that the user has clicked a positive icon or a negative icon associated with the modified content. In other examples, this feedback may be indirect feedback inferred from the user's actions. For example, if the user inputs instructions to further modify the modified content or discards the modified content, the systems described herein may infer negative feedback, while if the user approves the modified content to be used as part of an advertising campaign with no or minor changes, the systems described herein may infer positive feedback. In step 408, the systems described herein may provide this user feedback as training data to the LLM. For example, the systems described herein may provide the information that the LLM's output (i.e., the modified content) was tagged positively or negatively. In another example, the systems described herein may provide more detailed feedback, such as the specific modifications that the user made to the output.

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a processor, text content from an entity that stores the text content as a data object associated with the entity;
generating, by the processor, a prompt for a large language model that comprises the text content and directions for modifying the text content;
providing, by the processor, the prompt to the large language model;
executing, by the processor, the large language model, the execution causing creation of modified text content in accordance with the directions for modifying the text content from the prompt;
receiving, by the processor from the large language model, the modified text content; and
creating, by the processor, a new data object that stores the modified text content in association with the entity.

2. The method of claim 1, wherein:
receiving the text content comprises receiving the text content as input via a graphical user interface for creating content associated with the entity, the graphical user interface comprising multiple fields; and
creating the new data object that stores the modified text content comprises populating the multiple fields of the graphical user interface with the text content.

3. The method of claim 1, wherein the large language model comprises a specialized large language model trained on advertising entity data to modify text content associated with entities.

4. The method of claim 1, wherein:
the directions for modifying the text content comprise directions to translate the text content into a human-readable language that is different from an original human-readable language of the text content; and
the modified text content comprises text in the human-readable language.

5. The method of claim 1, wherein the modified text content comprises a JavaScript object notation object.

6. The method of claim 1, wherein the data object comprises an advertisement campaign and the text content comprises a plurality of advertisement blurbs.

7. The method of claim 1, further comprising:
identifying, by the processor, a plurality of images associated with the entity; and
selecting, by an algorithm executed by the processor, at least one image to pair with the modified text content, wherein the at least one image is selected based at least in part on the plurality of images.

8. The method of claim 1, wherein:
the text content comprises content configured to be displayed on a first category of physical device;
the modified text content comprises content configured to be displayed on a second category of physical device that is different from the first category of physical device; and
the directions for modifying the text content comprise instructions to configure the modified text content to be displayed on the second category of physical device.

9. The method of claim 1, further comprising:
receiving feedback from a user about the modified text content; and
providing the modified text content and the feedback to the large language model as training data.

10. The method of claim 1, wherein the entity comprises a third-party entity, wherein the third-party entity comprises an advertisement entity.

11. A non-transitory computer-readable storage medium tangibly storing computer program instructions capable of being executed by a processor, the computer program instructions defining steps of:
receiving, by the processor, text content from an entity that stores the text content as a data object associated with the entity;
generating, by the processor, a prompt for a large language model that comprises the text content and directions for modifying the text content;
providing, by the processor, the prompt to the large language model;
executing, by the processor, the large language model, the execution causing creation of modified text content in accordance with the directions for modifying the text content from the prompt;
receiving, by the processor from the large language model, the modified text content; and
creating, by the processor, a new data object that stores the modified text content in association with the entity.

12. The non-transitory computer-readable storage medium of claim 11, wherein:
receiving the text content comprises receiving the text content as input via a graphical user interface for creating content associated with the entity, the graphical user interface comprising multiple fields; and
creating the new data object that stores the modified text content comprises populating the multiple fields of the graphical user interface with the text content.

13. The non-transitory computer-readable storage medium of claim 11, wherein the large language model comprises a specialized large language model trained on advertising entity data to modify text content associated with entities.

14. The non-transitory computer-readable storage medium of claim 11, wherein:
the directions for modifying the text content comprise directions to translate the text content into a human-readable language that is different from an original human-readable language of the text content; and
the modified text content comprises text in the human-readable language.

15. The non-transitory computer-readable storage medium of claim 11, wherein the modified text content comprises a JavaScript object notation object.

16. The non-transitory computer-readable storage medium of claim 11, wherein the data object comprises an advertisement campaign and the text content comprises a plurality of advertisement blurbs.

17. The non-transitory computer-readable storage medium of claim 11, the steps further comprising:
identifying, by the processor, a plurality of images associated with the entity; and
selecting, by an algorithm executed by the processor, at least one image to pair with the modified text content, wherein the at least one image is selected based at least in part on the plurality of images.

18. The non-transitory computer-readable storage medium of claim 11, wherein:
the text content comprises content configured to be displayed on a first category of physical device;
the modified text content comprises content configured to be displayed on a second category of physical device that is different from the first category of physical device; and
the directions for modifying the text content comprise instructions to configure the modified text content to be displayed on the second category of physical device.

19. The non-transitory computer-readable storage medium of claim 11, the steps further comprising:
receiving feedback from a user about the modified text content; and
providing the modified text content and the feedback to the large language model as training data.

20. A device comprising:
a processor; and
a non-transitory computer-readable storage medium tangibly storing thereon logic for execution by the processor, the logic comprising instructions for:
receiving, by the processor, text content from an entity that stores the text content as a data object associated with the entity;
generating, by the processor, a prompt for a large language model that comprises the text content and directions for modifying the text content;
providing, by the processor, the prompt to the large language model;
executing, by the processor, the large language model, the execution causing creation of modified text content in accordance with the directions for modifying the text content from the prompt;
receiving, by the processor from the large language model, the modified text content; and
creating, by the processor, a new data object that stores the modified text content in association with the entity.
